(19) United States
(12) Patent Application Publication
(10) Pub. No.: US 2019/0185112 A1
(43) Pub. Date: Jun. 20, 2019

(54) Camera Buoy for Underwater Photography

(71) Applicant: Jamel W. Patton, Salt Lake City, UT (US)

(72) Inventor: Jamel W. Patton, Salt Lake City, UT (US)

(21) Appl. No.: 16/221,111

(22) Filed: Dec. 14, 2018

Related U.S. Application Data
(60) Provisional application No. 62/598,469, filed on Dec. 14, 2017.

(51) Int. Cl. B63B 22/24; G03B 17/08; H04N 5/232; H04N 7/18

(52) U.S. Cl. CPC B63B 22/24; H04N 7/185; H04N 5/23206; G03B 17/08

(57) ABSTRACT

A camera buoy defining a pentahedral body holds a camera in position to view a lure trailing the buoy. The buoy has a leader attached at two points, with preference for one given to an attachment bolt joining the camera and the buoy and having two eyelets for attachment to a main line and a lure line. An elastic band may interface with the second attachment point and further secure the camera. A sinker may be attached to a weaker lure line to sink the buoy and allow retrieval if the weaker line breaks. The buoy may be used with or without a lure.

### CROSS-REFERENCES TO RELATED APPLICATIONS

This Application claims priority as a non-provisional perfection of prior filed U.S. Application 62/598,469, filed Dec. 14, 2017, and incorporates the same by reference in its entirety herein.

### FIELD OF THE INVENTION

The present invention relates to the field of photography and more particularly relates to a floatable buoy on which to secure a camera for use in underwater photography.

### BACKGROUND OF THE INVENTION

Fishing is one of our oldest activities. For many, the tradition still holds a fascination and it is practiced for both the practice of obtaining food and for leisure. One particular aspect of fishing that is enjoyed by fishermen is the battle between the person and the fish, not only in the landing, reeling and capture of the fish, but also in the luring of the fish to take the bait. With the advent of underwater photography, this experience may be enhanced.

Many devices have been developed for the purpose of taking underwater photographs, with particular interest in use while fishing. Until recently, cameras have not been waterproof, so such devices tended to be chambers which would hold the camera in a dry, contained environment. These devices tended to be cumbersome and required precision in their operation, lest water seep inside and ruin the camera.

Many cameras, or even phones with cameras, are water resistant and can be submerged in water of a given depth for a particular amount of time before they are damaged. As such, many containers have adapted and are not quite waterproof anymore. However, there is still a danger that if the container is not buoyant enough, and a securement line breaks, the camera may be lost to the depths of a body of water and never found again. Unfortunately, lighter containers tend to lack stability and can be frustrating to operate as the operator may not get a decent, stable, shot.

There are also other uses of such underwater cameras, such as archeological, geological, environmental, or forensic investigations, in which a stable underwater camera support may be of invaluable use.

The present invention is a buoy which may hold a camera facing a lure on a fishing line. The shape of the buoy gives it unexpected stability while being a true buoy, if the attachment line is broken, the camera will tend to float in the water. The buoy may provide a stable platform on which to mount a camera and acquire excellent pictures and video of any activity at the lure, even when moving in water. Being a buoy, the device is simple to operate and manufacture. The present invention represents a departure from the prior art in that the buoy of the present invention allows for a stable attachment to a camera for underwater photography.

### SUMMARY OF THE INVENTION

In view of the foregoing disadvantages inherent in the known types of containers for underwater photography, an improved buoy may provide a stable interface for a camera that meets the following objectives: it is easy to manufacture and use, it will prevent the camera from entirely sinking to the bottom of a body of water in the event a line is broken, it is stable, directing the camera towards a lure even when the line is motion (excepting thrashing by the prey). As such, a new and improved buoy may comprise a pentahedral body with a rearward leader and lower camera mount attached thereto in order to accomplish these objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side elevation of the camera buoy, assembled with a camera, floating in water.

FIG. 2 is a side elevation of the camera buoy and camera assembly of FIG. 1, lying on its back surface.

FIG. 3 is a partial breakaway view of the camera buoy and camera assembly of FIG. 2.

FIG. 4 is an exploded view of the camera buoy and camera assembly of FIG. 2.

FIG. 5 is a top plan view of the camera support of FIG. 3.

FIG. 6 is a bottom elevation of the camera support of FIG. 3.

FIG. 7 is a slight front perspective view of the camera support of FIG. 3.

FIG. 8 is a rear plan view of the camera support of FIG. 3.

FIG. 9 is a side elevation of the camera support and camera assembly of FIG. 1, diving.

FIG. 10 is a side elevation of the camera support and camera assembly of FIG. 1, while either trolling or reeling.

### DETAILED DESCRIPTION OF THE PREFERRED EMBODIMENT

With reference now to the drawings, a preferred embodiment of the buoy is herein described. It should be noted that the articles “a”, “an”, and “the”, as used in this specification, include plural referents unless the content clearly dictates otherwise.

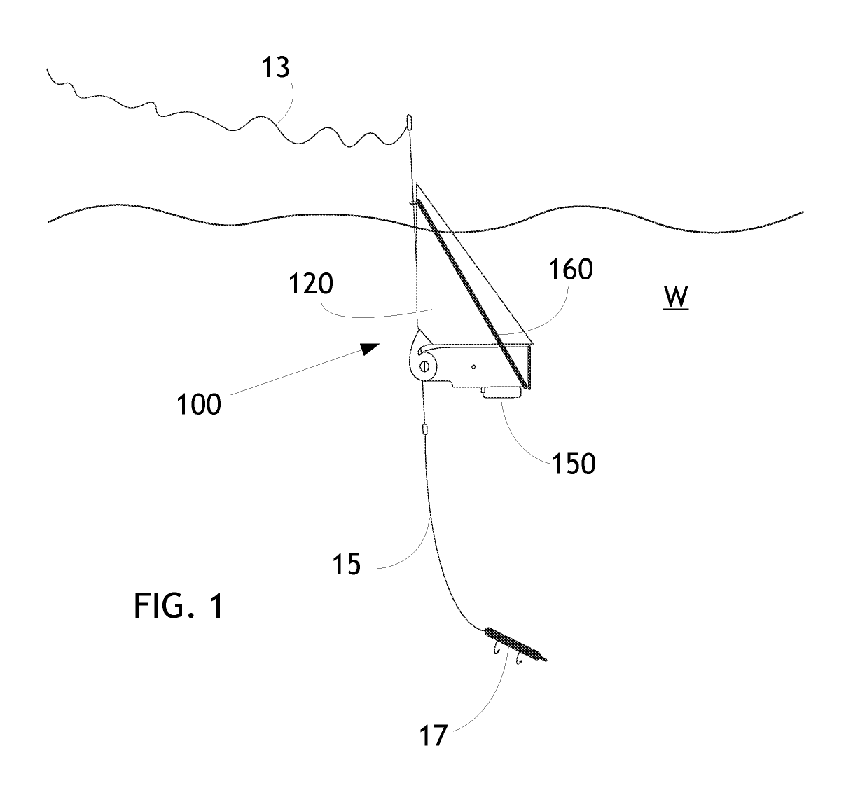

With reference to FIG. 1, a fully assembled buoy and camera 100 are floating on the surface of a body of water W. The assembly 100 is connected to a line 13 and supports a leader line 15 that supports a lure 17. In an unweighted state, the assembly 100 is designed to float. It should be noted that relative terms such as “bottom,” “top,” “front,” and “back” are defined based on this figure, with the camera mount 130 on the bottom and the leader 140 attached to the back.

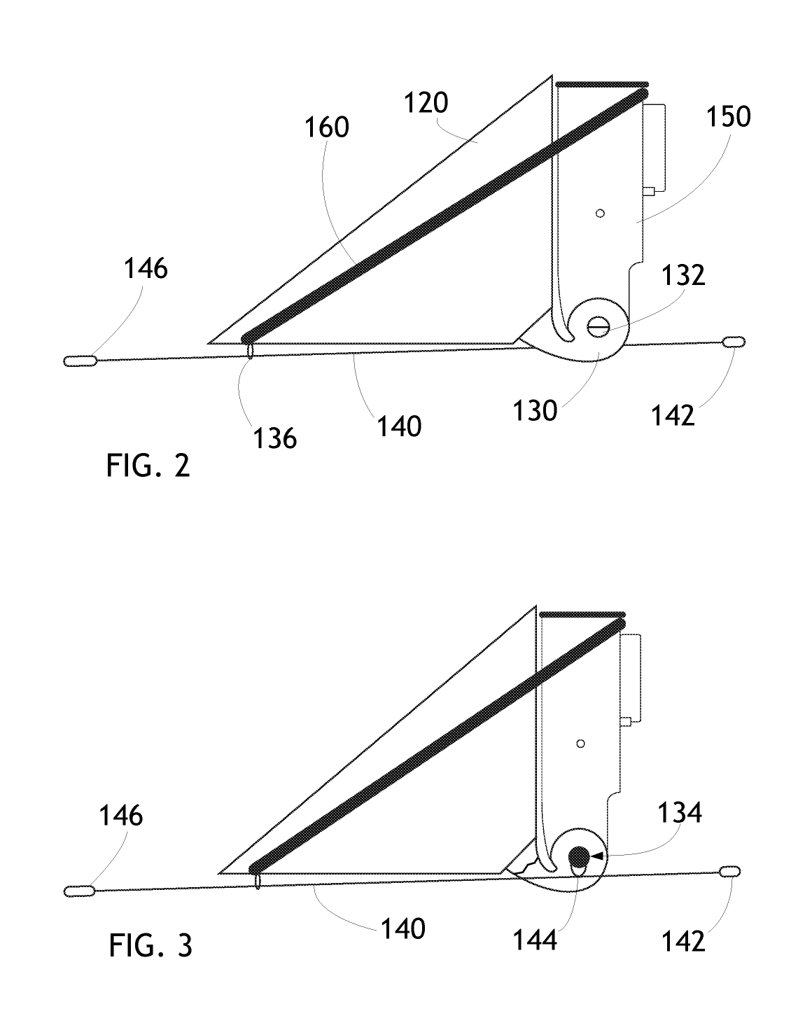

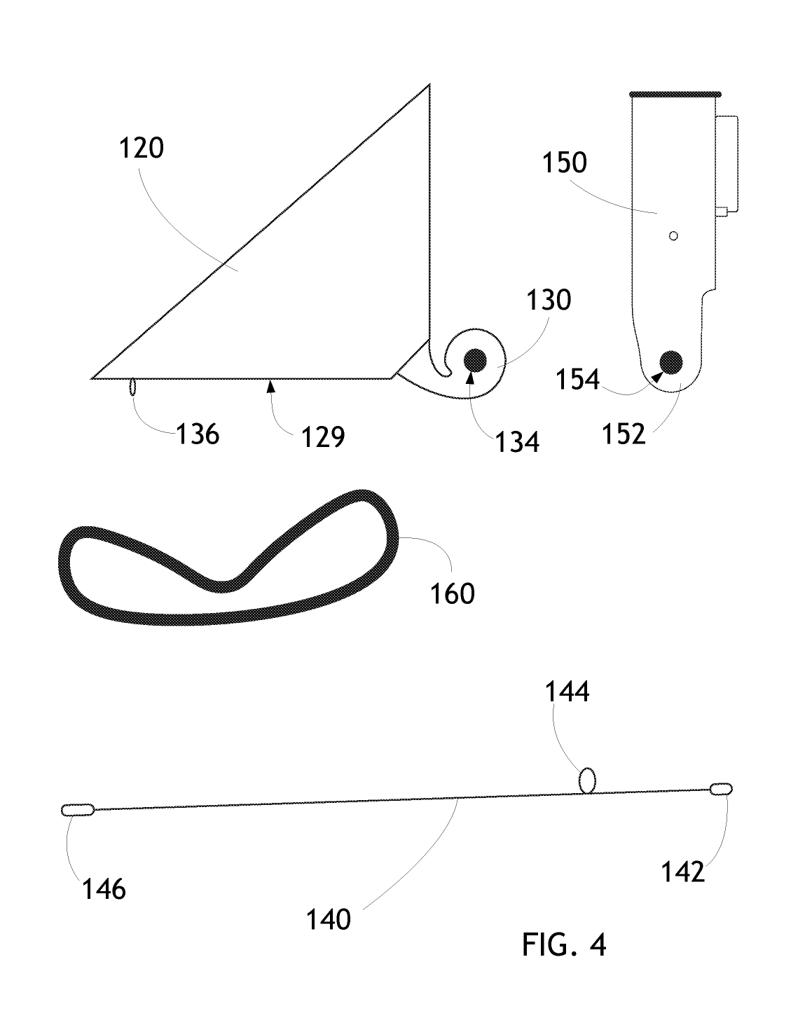

The entire assembly 100 comprises a camera 150 and a leader 140 connected to buoy 120 (FIG. 2) with an elastic band 160 optionally used to help secure the camera 150 to the buoy 120. The individual components of the assembly 100 are better seen in the exploded view of FIG. 3. Of note, leader 140, which is preferred to be made of metal wire, has two ends 142, 146 terminating in eyelets for the attachment of line. There is also a support loop 144 in the middle of the leader 140. The buoy 120 has a connection interface 130 which matches a corresponding interface 152 of the camera 150, both of which may have corresponding holes 134, 154. A bolt 132 generally secures the buoy and camera 150 together at their respective interfaces 130, 152. This leaves the camera 150 exposed to the environment outside of the buoy body 120. Support loop 144 may be fitted about the bolt 132 (shown generally in FIG. 4, with the bolt 132 removed for clarity) in the proximity of the holes 134, 154. A buoy loop 136 is presented on the bottom surface 129 of the buoy and serves as an additional connection point for the leader 140 as it is threaded through said buoy loop 136. This then provides the leader 140 with two points of attachment to the buoy 120, both being along a center line of the same, and this enhances the stability of the buoy 120. Elastic band 160 may be fitted about a top portion of the camera 150 and about the buoy loop 136 to provide a second point of contact for the camera 150.

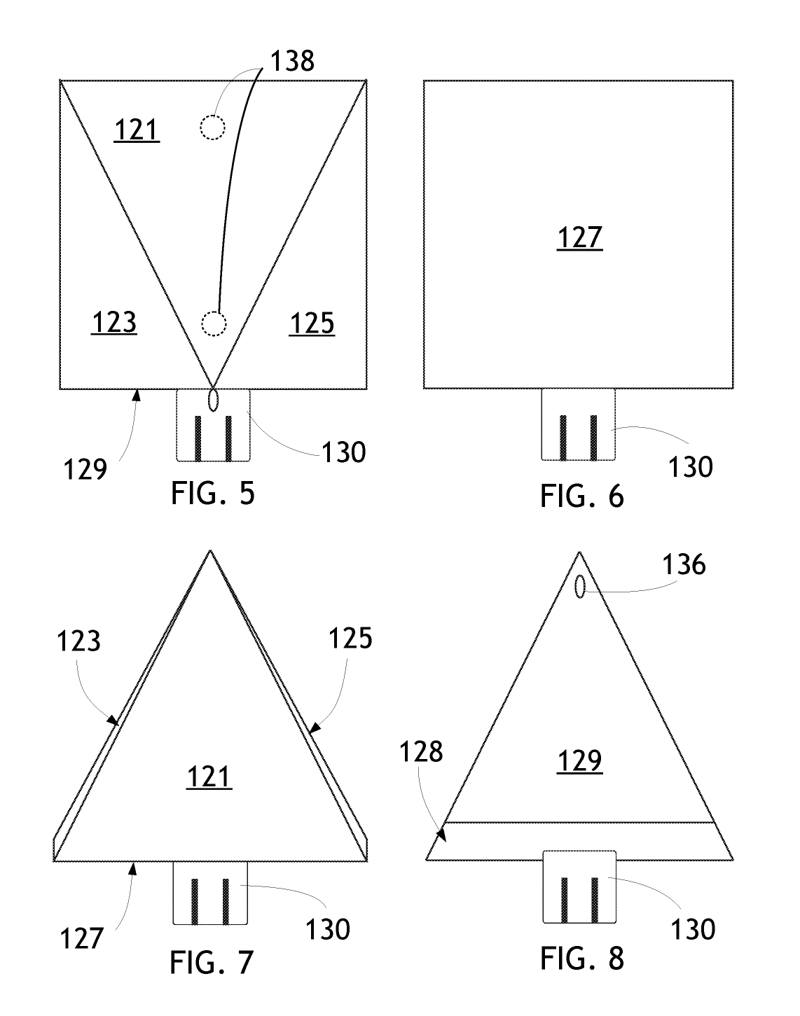

The buoy 120 body itself is shown in FIGS. 5-8. The buoy body 120 is generally a pentahedron, with a triangular back 129 and a generally square bottom 127 surface which are at right angles to each other, thereby making the buoy body 120 a “right pentahedron.” The front and back surfaces are similarly shaped triangles with the front surface 121 angling backwards to form a tip with the back surface 129 at the top of the buoy. Side surfaces 123, 125 complete the pentahedron and enclose a sealed volume which provides buoyant force when the buoy 120 is in water. Many different camera mounts exist. The depicted camera mount 130 extends from the joint of the back 129 and bottom surfaces 127 and extends outwards. A chamfer 128 may or may not be present to aid in the positioning of the camera mount 130.

In use, shown in FIGS. 1, 9 and 10, the buoy assembly 100 is attached to a line 13 at the rear leader eyelet 146 while a lure 17 at the end of a lure line 15 is attached to front leader eyelet 142. With no added sinker, the buoy assembly 100 may serve as a bobber and the camera 150 should point straight downwards. Also, if the properly weighted, the camera 150 may be only partially submerged, which allows wireless communication between the camera 150 and any other of the user's equipment.

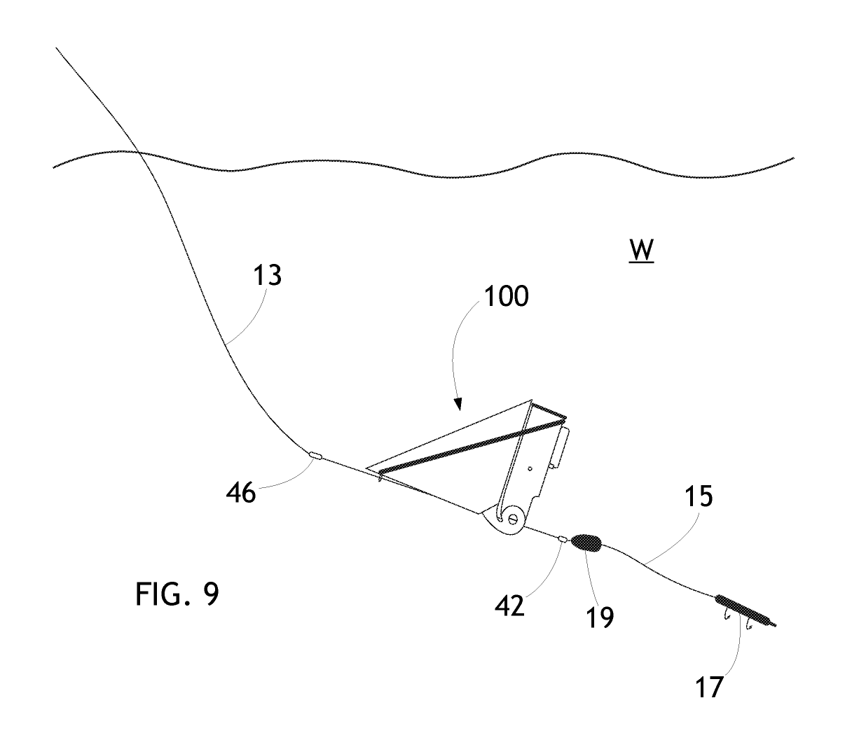

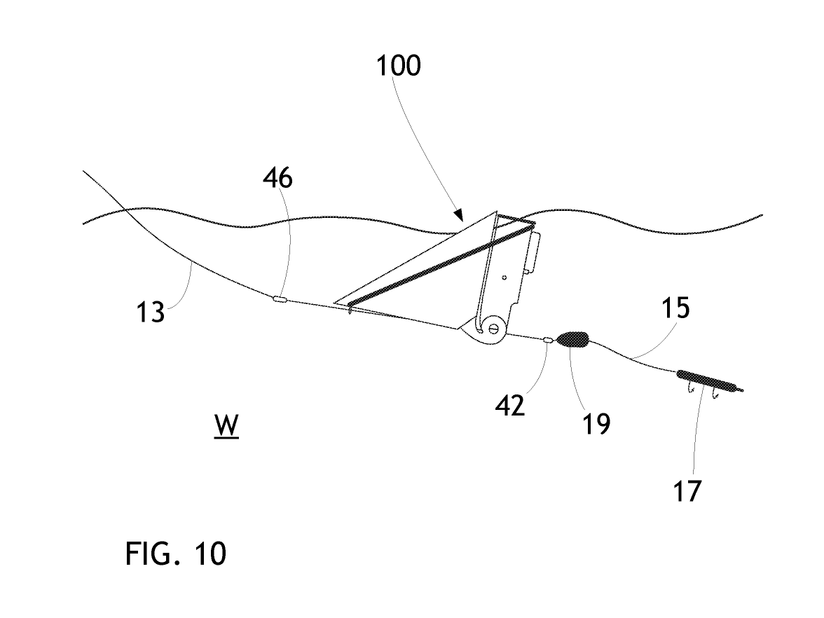

A sinker 19 may be added to the lure line 15 in order to provide additional ballast and at least partially submerge the assembly 100 by balancing its buoyancy (FIG. 9). In the event of the line breaking, the lure line 15, where the optional sinker 19 is attached, should be the line to break, thereby releasing the sinker from the buoy and allowing the camera 150 to be retrieved. Camera 150 points towards lure 17 and can then capture any activity in its field of view, even when the line is being reeled in or towed in a trolling operation (FIG. 10).

The pentahedron shape of the buoy is unique and provides an unexpected amount of stability when traveling through the water. The angled top cuts through the water while providing enough equal forces on the sides, top and back surfaces to maintain a relatively stable positioning of the camera 150 to keep lure 17 in view even while moving. This angular shape is unexpected based on the known laws of fluid dynamics and contravenes accepted understanding of these laws.

The camera support may be of any type known or later developed in the art. The depicted support is preferred as this allows the leader 140 to have a point of attachment at its middle loop 144. It should be readily understood that equivalent structures may be developed and utilized, should alternate camera supports be utilized, and such equivalent structures should be deemed to be a part of the invention. The buoy's dimensions may be adjusted to provide more or less buoyant force, as determined by the size of the camera it is designed to hold. The buoy may also be designed to hold a light source in order to illuminate the area in front of the camera. Such light source may be integrated into the shape of the buoy body 120 or the buoy body may be adapted to fit an external source. At least one small hole 138 may be added to allow water to seep into the buoy body 120 (dashed lines, FIG. 5) which would provide a slow sinking action to the buoy. A second vent hole may be required for this action and one or more plugs may be provided to make this action optional. However, such an addition, without adding at least one non-floodable sealed chamber within the buoy body, would contravene the goal of keeping the buoy, and associated camera, from sinking to the bottom of the body of water and being lost. Fins may also be added to the buoy body 120, however, the shape of the buoy seems to provide sufficient stability without such additional structures. It should be readily understood that for operations where the need to catch or view fish are absent, the lure 117 and possibly lure line 115 may also be absent.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A camera buoy comprising:
a polyhedral buoy body having a plurality of sides defining a sealed volume;
a leader attachable to the buoy body and having two ends;
a camera mount attached to one end of the buoy body, the camera being exposed to an outside environment.

2. The camera buoy of claim 1, the leader further comprising a support loop between the two ends and interfaces with the camera mount to aid in securing the leader to the camera buoy.

3. The camera buoy of claim 2, further comprising an attachment loop on one side of the polyhedral buoy body for securement of the leader to the camera buoy.

4. The camera buoy of claim 1, further comprising an attachment loop on one side of the polyhedral buoy body for securement of the leader to the camera buoy.

5. The camera buoy of claim 1, the polyhedral buoy body being a right pentahedron, with a generally square bottom side and a triangular back side forming a right angle with each other.

6. The camera buoy of claim 5, the buoy body further comprising a front side originating from the bottom side opposite the back side and joining the back side at a tip.

7. The camera buoy of claim 6, the leader further comprising a support loop that interfaces with the camera mount to aid in securing the leader to the camera buoy.

8. The camera buoy of claim 7, further comprising an attachment loop on one side of the polyhedral buoy body for securement of the leader to the camera buoy.

9. The camera buoy of claim 6, further comprising an attachment loop on one side of the polyhedral buoy body for securement of the leader to the camera buoy.

10. A method of underwater photography comprising placing a camera on the camera buoy of claim 1 and directing the camera into the water.

11. The method of underwater photography of claim 10, further comprising attaching a line to a rear end of the leader and a weaker line to the front end of the leader and also attaching a sinker to the weaker line.

12. The method of underwater photography of claim 10, the camera buoy residing in a body of water such that the camera maintains wireless communication with other equipment.
